(19) United States
(12) Patent Application Publication
(10) Pub. No.: US 2008/0041932 A1
(43) Pub. Date: Feb. 21, 2008

(54) Casino Deposit Unit and System

(75) Inventors: Bryan James Christophersen, Hampshire (GB); Alexander Charles Harold James, Hampshire (GB)

Correspondence Address: OLIFF & BERRIDGE, PLC, P.O. BOX 320850, ALEXANDRIA, VA, 22320-4850, US

(73) Assignee: De La Rue International Limited, Hampshire (GB)

(21) Appl. No.: 11/795,026

(22) PCT Filed: Jan. 20, 2006
(86) PCT No.: PCT/GB06/00202

§ 371 Date: Aug. 20, 2007

(30) Foreign Application Priority Data
Jan. 20, 2005 (GB) 0501196.0

(51) Int. Cl. G07D 11/00

(52) U.S. Cl. 235/379; 463/25

(57) ABSTRACT

A casino table deposit unit (100) is presented for processing and storing documents used within a casino environment. Each unit (100) is located on or near a gaming table within the casino and is adapted to aid casino staff with customer transactions. A plurality of these casino table deposit units (100) are connected within a networked system and are further adapted to communicate with a central server (207). Details of documents processed at each table deposit unit (100) are transmitted over a range of communication means to the central server (207), where the details are input to a data processing application. The data processing application consolidates the inputted information and stores the results in a database (209). This database (209) is then used by a further server (210) in a reconciliation operation performed on the contents of each table deposit unit (100) at the end of a gaming day. A casino currency is also proposed to work in conjunction with the deposit unit and extended system.

The invention relates to a casino management system for efficient automated deposit and auditing of articles of value used within the casino environment. In particular, the present invention relates to apparatus and methods to achieve this system.

### DEFINITIONS

A “casino” is any gaming establishment.

A “gaming table” is a location or table used for gambling within the casino. It may be equipped with a gameboard and slots for chips and cash deposits. Common games include blackjack, roulette, poker and craps. If a table is “live” it signifies that it is in operation and open for players.

A “pit” is an area of the casino in which a group of gaming tables are arranged. The tables are usually arranged elliptically around a centre area that is usually restricted to dealers and other casino staff.

An “electronic gaming terminal” provides a remote terminal at which bets can be placed on a live game. For example, a terminal may display a roulette wheel viewed by a digital camera. The customer can place a bet, and win tickets that can be redeemed for cash, at the terminal based on the results of a spin of the roulette wheel.

The “gaming day” is a time period within which a gaming table is open to take cash deposits.

A “croupier” or “dealer” is a member of casino staff who operates the gaming table. They are usually responsible for overseeing monetary transactions in exchange for gaming chips.

An “inspector” is a member of casino staff who oversees a small number of gaming tables and croupiers. In particular they are responsible for spotting possible fraudulent transactions by either staff or customer.

A “pit boss” is a member of casino staff who is responsible for overseeing a pit. They oversee the inspectors, providing the next level of management in the casino hierarchy.

A “chip” is an article of value, usually a small plastic token, used within the casino. Normally they are provided in a number of denominations and are used to place bets at gaming tables. Items of monetary value can be exchanged for chips at the gaming table under the supervision of a croupier.

A “cash drop” is the name given to the deposit of items of monetary value at a gaming table or machine terminal.

A “cash-desk payout” is a situation in which a winning ticket printed by an electronic gaming terminal is exchanged for a cash sum at a cashier office.

A “meter-in reading” is taken from a meter attached to an electronic gaming terminal which records the amount of cash deposited into the terminal.

A “meter-out reading” is taken from another meter attached to an electronic gaming terminal, which records the equivalent amount of cash payed out in tickets for winning bets.

A “clicker” is a pen-like apparatus used by the croupier that records the number of times a particular button on the apparatus has been pressed or “clicked”. Each “click” is used to estimate a unit amount of money deposited in a cash transaction.

A typical casino environment will now be described. Within the casino a standard cashflow cycle will operate as follows: First, a customer or casino member will enter the casino with a certain amount of cash upon their person or, alternatively, retrieve cash from cashier stations or automatic teller machines (ATMs) within the casino. If the customer wishes to use large cash amounts, as is often the case with high stakes gaming, the customer can be offered the choice of using plastic plaques, which represent monetary quantities of high denominations, instead of impractical bundles of banknotes. In the UK, these plaques can have monetary values of up to £5000 and in several countries the casino is legally required to supply these articles instead of large cash withdrawals. This is in order to reduce the risk of money laundering and other fraud.

The customer can withdrawal or purchase a combination of cash and plaques at a cashier station using known means, for example cash, credit cards, cheques, debit cards etc. The customer will then proceed to one of the gaming tables. At the table, he is able to place bets on the game present. If he so requires, the customer will exchange a certain amount of cash, or perhaps cheques, plaques or other items of monetary value, with the croupier for a number of chips. These chips can then be used to place the bets.

The croupier normally mediates the cash exchange. He briefly, if at all, checks validity of the cash exchanged, usually by eye, and then deposits it in a slot in the table. He counts the amount deposited on the “clicker”, each “click” representing a given unit amount money, for example ten pounds. Therefore, whether the customer used five ten pound notes or one fifty pound note would be indiscernible to later investigation, as the croupier would click the device five times in both cases. At regular intervals an inspector or pit boss will visit the croupier and record the value recorded on the “clicker”. This then provides a very rough estimate of the cash deposited at a table. The cash is placed and resides in a drop box, which may or may not be secure, under or near the gaming table. This process continues for multiple customers throughout the gaming day. If a customer is using plaques of high value the croupier will briefly check the validity of the plaque before depositing it in the drop box. As these plaques are of high denomination it is impractical to use the “clicker” to record their value. Thus, the croupier commonly notes these transactions separately, which becomes difficult with a constant flow of custom.

In regard to electronic gaming terminals, an inspector or pit boss will regularly monitor each set of terminals at specific intervals to record the meter-in and meter-out readings. The difference between a running total of each reading for each terminal can then be used to estimate the takings of each terminal and also estimate whether the terminal needs to be emptied. On these rounds, the inspector or pit boss may also record the “clicker” estimates of each croupier, giving a crude estimate of table deposits.

When the gaming day comes to an end and the casino closes its doors to customers, a pit boss will supervise the collection of the drop boxes from the gaming tables. These boxes will then be taken to a central count room within the casino, where the total cash taken at each table will be counted. Currently, four or five people are required in the count room in order to insure this count is carried out securely, and each of these members of staff must be personally vetted to prevent fraudulent practice. Each person will be responsible for counting and denominating the contents of a number of drop boxes, or alternatively responsible for recording the totals in a ledger book or similar paper-based system. These accounts can then to taken to central management, where the final accounts for the day can be tallied. This can be performed manually or through the use of standard computer spreadsheets.

In most casinos there are too many electronic gaming terminals to empty each terminal as regularly as the drop boxes. Therefore, terminals are often emptied on a rota system, for example emptying a fixed number of terminals a day, or certain sets of terminals on specific days.

There are several problems with the known casino management systems. Firstly, it is difficult to provide accurate variance estimates for the casino cash flow due to the inefficiency of the estimation methods previously described. Furthermore, in cases where such estimates can be provided, the counts of cash deposited at each table can produce variances of up to 40% of the total deposited. This may be due to a number of factors including: poor estimates of cash deposited using the “clicker” system, transaction errors due to the stressful environment, ledger errors, mistakes in counting and the loss or misplacement of cash in the count room. This variance then provides an opportunity for fraud, as management can never be sure whether accounting variances are innocent or malicious.

The opportunity for fraud is open to a number of parties: the croupier, the customer, management, the count room staff, or any combination of all four. At the gaming table, the croupier has little time to check the validity of cash deposits or accurately denominate the amount deposited because the turnover of the games has to be kept as fast as possible to provide efficient business and customer satisfaction throughout the gaming day. For this reason many casinos use a variety of surveillance systems, where the pit boss will have access to CCTV footage of the gaming tables and the customers in order to spot fraudulent transactions by eye. However, the pit boss must oversee multiple gaming tables, at which many transactions may be taking place at any one time.

These opportunities for fraud have in the past led to casinos being infiltrated by organised crime. To combat this infiltration there are current regulations in the UK stipulating that all variance in casino takings over 5% will require management investigation. Similar regulations also exist in other countries. As a typical variance in deposits is 10% casinos are often left with potentially serious compliance issues. Furthermore, as a count is only performed at the end of the day, or possibly the next day, the casino may not realise that cash has been taken or a problem has occurred until much later.

A further difficulty with the current system is that a casino often has difficulty in predicting their cash flow for a certain evening. If a certain customer wins a large cash prize they often have to order more money from the banks to pay this. These transactions impose a large expense on the casinos. Also, as the high value plaques commonly have a simple construction and are made from moulded plastic, they provide opportunity for forgery.

In order to try to reduce these problems a number of methods have been, proposed. These include: dispensing with cash and using a customer swipe card, requesting that all transactions happen at a supervised cash desk and advanced customer tracking through CCTV monitoring. Whilst providing a small amount of reassurance these methods often introduce additional problems, such as additional costs, complexity, and required management or technical expertise.

In accordance with the present invention, we provide a method of operating a document deposit apparatus comprising the steps of supplying at least one document to a document inlet area; processing the at least one document; selectively illuminating a manually operable input means so as to inform a user of the success or otherwise of the processing step; setting the function of the input means dependent on the result of the processing step; and selectively activating the input means to implement the function.

This method allows a croupier to quickly and efficiently deposit cash at a gaming table. By selectively illuminating a manually operable input means, which could be provided by a single button, a switch or a single location on a touch screen, the croupier can immediately see the result of the document processing. By further setting the function of the input means the croupier can be guided in his actions concerning the deposit of cash thus saving time and decreasing the risk of fraudulent transactions. These functions may be, but are not limited to, depositing cash, sending an alert to a remote server, selecting the correct deposit apparatus, and deactivating the input means.

The selective illumination could take the form of flashing the input means upon different processing results or alternatively illuminating the input means if the process is successful and not illuminating the input means if the process is unsuccessful. Preferably, the method also further provides the steps of selectively illuminating the input means a first colour, for example, green, if the process step was successful or alternatively selectively illuminating the input means a second colour, for example red, if the process step was unsuccessful. These colours can be easily seen by the croupier. Furthermore, if the process is successful, the function of the input means can be set to allow the at least one document to be deposited into a deposit store upon activation of the input means. This then saves the croupier time in the successful case and confirms all cash placed onto the deposit apparatus is deposited into a secure cassette. Alternatively, the input means can be disabled if said process step was unsuccessful, thus preventing the croupier from accidentally or maliciously depositing suspect cash.

The processing can take the form of determining one or more characteristics of the at least one document, for example its validity or denomination. Therefore, an unsuccessful process could arise if a document could not be authenticated or denominated, or if a mechanical error, such as a document jam, occurred. An additional temporary store can be provided, in which processed documents can be deposited. Thus, if the processing is unsuccessful, the croupier or management staff can inspect the rejected documents. Gaining access to this temporary store, for example through a lockable escrow door, can also reset the illumination condition and function of the input means to an initial state.

The current invention also provides a method where a user can be designated by first activating one input means from a plurality of input means. The activated input means is then associated with the user, and is selectively illuminated after document processing. Thus two croupiers can operate a deposit apparatus shared between two gaming tables. As an example, each side of the apparatus could have a button corresponding to a respective table, and each croupier would press the button associated with his side of the table to deposit cash.

In accordance with another aspect of the current invention we provide a method for operating an article of value deposit and audit system within a casino environment comprising depositing a plurality of articles of value onto at least one deposit apparatus located at a gaming table; processing said plurality of articles of value at the gaming table using said deposit apparatus; storing the plurality of articles of value in a secure container within the deposit apparatus; transmitting a first set of information relating to the article of value processing step over a communication means to a central location; and storing said first set of information at the central location.

This method thus provides steps to efficiently keep track of cash deposits at gaming tables, which in known casinos has been difficult. This, in turn, can reduce casino profit-loss and facilitate compliance with local legislation. Cash received at gaming tables in various transactions can be validated and denominated within the processing step, and securely deposited in a container. The first information obtained within each processing step, such as the denominations and validity of deposited notes, can be sent to and stored at a pit boss station, enabling the pit boss full access to accounting information. He can then use this information to accurately trace cash flow within the casino or to stop errors or fraudulent activity.

The method also provides steps of controlling the table deposit apparatus from a central location by the pit boss, thus enabling the apparatus to be locked-down or disabled at the end of a gaming day or on receipt of an error, or opened for deposit at the beginning of a gaming day. Information about the status of each deposit apparatus can also be interrogated, and in certain embodiments error data can be paged to management staff on the casino floor. This then greatly increases the efficiency of the management team.

Preferably, the secure container from the deposit apparatus is collected, possibly at the end of the gaming day, and the cash contents of such a container processed in order to provide a second set of contents information. This second set of information can be reconciled with the first set of information to provide accurate variance estimates for accounting purposes and highlight any disparities between the two sets of information. The output of the reconciliation allows a master count sheet to be produced in a tabular or spread-sheet format. This saves much time when compared to the known manual methods.

In accordance with a third aspect of the current invention, we provide a method for providing payment in a casino environment comprising the step of purchasing a casino currency by exchanging the casino currency for gaming chips at a gaming table or cashier, wherein the casino currency includes at least one anti-counterfeit security feature. This casino currency may not be legal tender. This casino currency can also be distributed to winning customers instead of cash, plaques or tickets. Thus it can provide greater security for both customer and casino over plaques and tickets, and provide greater convenience for both customer and casino when compared to large cash payouts.

This casino currency can be used in the methods previously specified to provide greater security within the casino. It is designed to supersede articles of value such as plaques, which can be easily counterfeited. It also enables a more customer-friendly currency, similar to legal tender, for high stakes gaming. Preferably, the security features comprise one or more of infra red or UV patterns, mould-made watermarked paper with a windowed cleartext thread, all over lithographic print on face and reverse of the currency, anti-copy print features, infrared denomination encoding with type matched inks, infrared blind lithographic print background, a unique sequential serial number, intaglio printing, holographic patches or stripes, bar codes, or radio frequency identification tags on threads.

### BRIEF DESCRIPTION OF THE FIGURES

FIG. 1 is a side view of a table deposit unit from the front and one side;

FIG. 2 is a systems diagram showing how the different systems components interlink;

FIG. 3 is a process diagram illustrating the use of the table deposit unit by a single user and the function of the quick key;

FIG. 4 is a process diagram demonstrating the use of a table deposit unit by multiple users;

FIG. 5 is a process diagram demonstrating steps S303 and S405 in more detail;

FIG. 6 is a process diagram demonstrating the steps involved at the beginning of a gaming day;

FIG. 7 is a process diagram demonstrating the steps involved at the end of a gaming day;

FIG. 8 is a process diagram demonstrating the polling of a table deposit unit by central control software;

FIG. 9 is a process diagram demonstrating the step S805 in more detail;

FIG. 10 is a process diagram demonstrating the steps involved when a table deposit unit needs to be shut down;

FIG. 11 is a process diagram demonstrating the reconcile operation at the end of the gaming day;

FIG. 12 is a process diagram demonstrating polling electronic gaming terminals;

FIG. 13 illustrates a user interface for opening and closing the gaming tables;

FIG. 14 illustrates the master count sheet produced at the end of the reconcile operation.

FIG. 15 is a block diagram of a control system for the table deposit unit.

### DETAILED DESCRIPTION

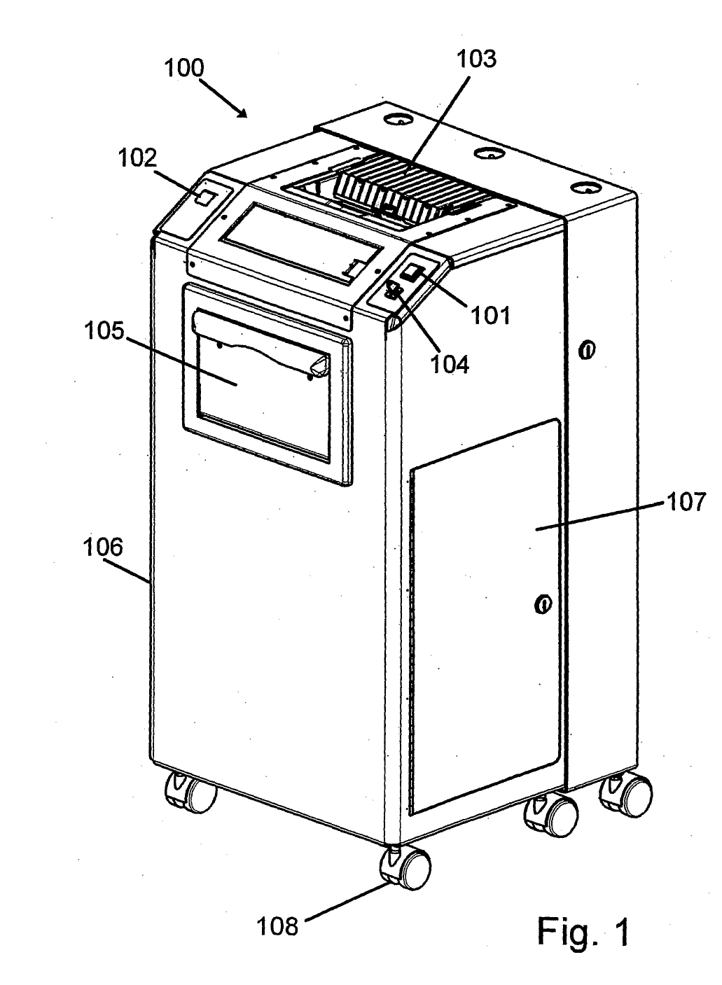

FIG. 1 illustrates an embodiment of a table deposit unit (TDU) 100. This unit is a central part of the casino management system and is placed at a gaming table to take the place of the standard drop box. The table deposit unit 100 can either be placed next to a single table or between two tables, in which case both tables use the same TDU 100 for cash deposits. Whilst the embodiment shown is designed to stand on castors 108 next to or at the end of the table it is also possible that the apparatus could be mountable within the table itself. If castors 108 are used the TDU is fitted with adjustable spacer modules to match the TDU position to the table height. The TDU 100 may also be equipped with a key switch 104 to enable only authorised key holders to activate the unit.

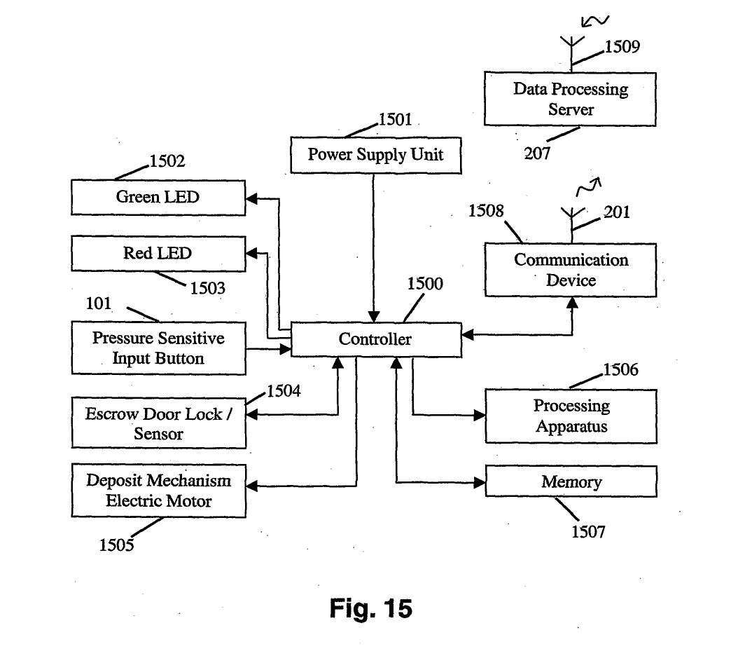

FIG. 15 illustrates a control system for use within the TDU 100. An exemplary TDU comprises a document counter 1506 which provides the document inlet 103 and is mounted in metal housing 106 below this inlet. The counter 1506 is employed to count, denominate and validate documents of value and transport them to a temporary or escrow store located behind an escrow door 105. The temporary or escrow store (not shown) is used as a holding area for any deposits. Below the temporary store resides a secure cassette (not shown), which is designed to be mounted within a steel enclosure within the metal housing 106. Access to this cassette is facilitated using a lockable access door 107. Typically, the bottom platform of the temporary store is designed to move back into the housing of the TDU to enable deposits to drop into the cassette. This deposit mechanism is typically actuated using one or more electric motors 1505. To facilitate electronic control of the TDU 100, each unit is equipped with a TDU controller 1500 provided by a printed circuit board or other known apparatus and an associated power supply unit 1501. An example of the TDU 100 is disclosed in EP-A-0613107.

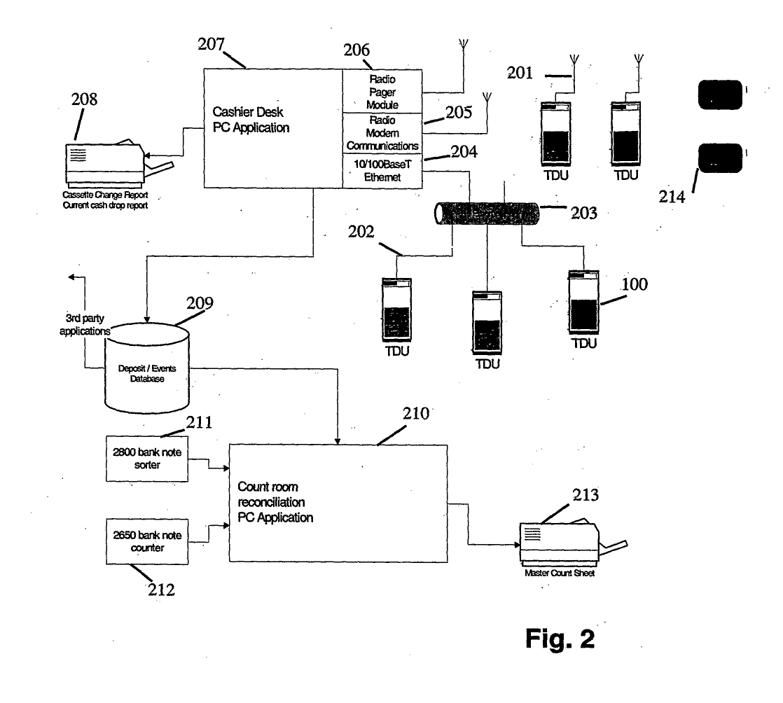

Referring to FIG. 2, the TDU 100 can now be seen as part of the larger management system. Each TDU 100 is connected to a data processing application resident on a variety of personal computers or networked servers 207, 209 within the casino. This is not a limiting case, as one skilled in the computer arts would understand the methods of the data processing application could alternatively be realised on dedicated hardware. The data processing application is distributed across two locations within the casino: one installation is based within the pit boss or cashier offices and one installation is located within a count room. One of the data processing servers 207 can be connected to each TDU 100 via a variety of communication means. These can include, but are not limited to, a direct serial connection (not shown), an Ethernet connection 202,203,204 or a wireless RS modem connection, 201, 205. If the TDU 100 is connected via an Ethernet connection 202 then each TDU 100 can be fitted with a 10 baseT Ethernet device server 204, as known in the art. If a TDU 100 is required to communicate with the data processing server 207 wirelessly then each TDU 100 can be equipped with a wireless networking card, for example an RS232 radio modem, and aerial 201. The data processing server can oversee the running of these communication systems in ways known to those skilled in the art.

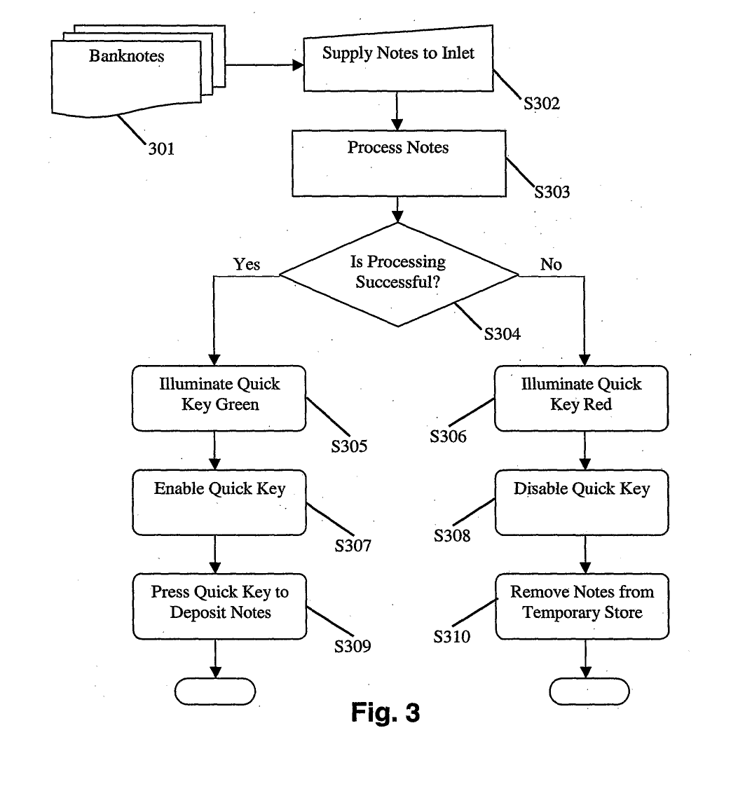

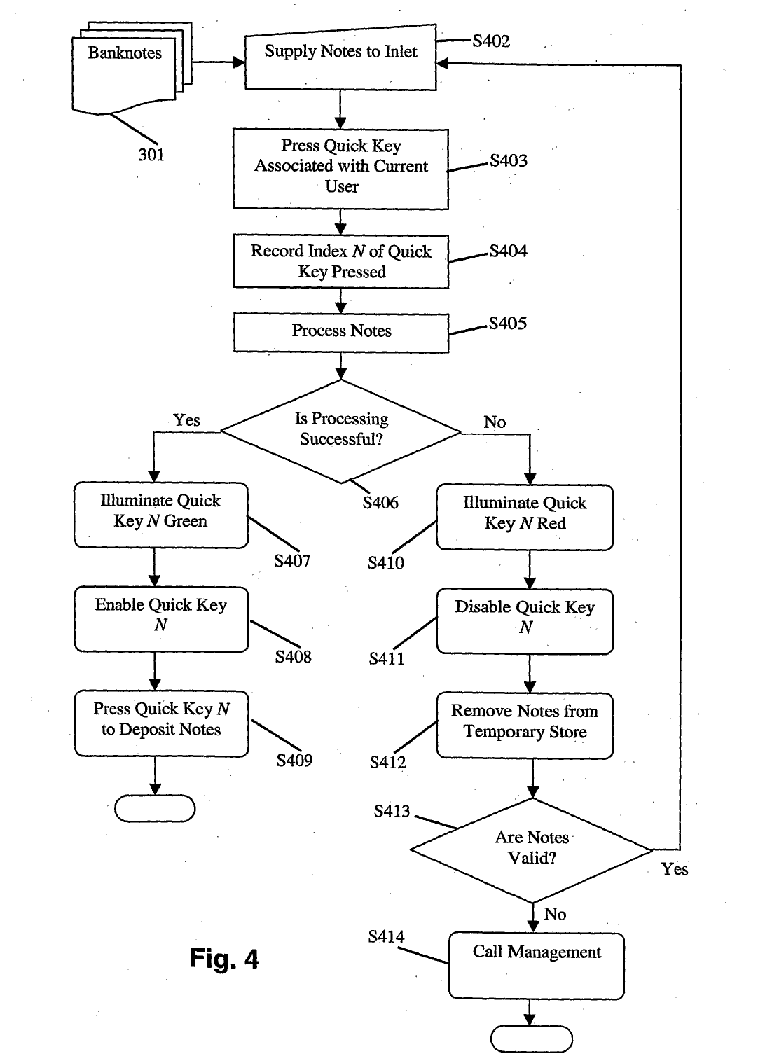

The operation of the TDU 100 will now to explained with reference to FIG. 3 and FIG. 4. The process beings when a customer or casino member approaches a gaming table and asks to buy a certain number of gaming chips. The article of value used in this transaction will vary from casino to casino but common articles comprise bank notes, cheques, coins, specially designed casino currency, or casino plaques. Whilst describing the operation of the TDU, reference will be made to banknotes 301, but it is understood that any other article of value could be used.

Once the amount of gaming chips has been confirmed, the customer hands over the appropriate number of banknotes 301 to the croupier. The croupier receives the notes 301 and places them on the article inlet 103 of the TDU 100, as demonstrated in step S302. The TDU 100 is able to feed a total of a hundred notes 301 of up to twenty denominations or sizes per deposited bundle. The document size range is optimally 120 mm×62 mm to 160 mm×82 mm and optimal document thickness is between 0.075 mm to 0.15 mm. If there is only a single TDU 100 for the current table the notes 301 will automatically feed through into the unit. The TDU can be configured so that the notes 301 will not be fed into the TDU unless the escrow door 105 is shut. Within the unit 100 there resides the document counter 1506 for processing the deposited notes. This processing is represented in step S303 of FIG. 3. Once the processing has been completed the notes 301 are deposited in the temporary store which resides behind the escrow door 105. With reference to FIG. 15, the document counter 1506 will then send information concerning the result of the processing operation to the controller 1500. If the processing has been successful then the quick key 101 will be illuminated green S305. This can be implemented by providing power to a green light emitting diode (LED) resident below the button through the TDU controller 1500. Alternatively, a number LEDs of any colour could be mounted in a variety of positions within the area of the quick key 101, for example encircling the quick key 101. The TDU controller 1500 also enables the same quick key 101 on successful processing, S307. The croupier now knows that the operation has been successful and can press the quick key 101 to deposit the notes 301 into the secure storage cassette S309. This cassette resides behind lockable door 107.

If the processing is not successful the quick key 101 is illuminated red, S306. Again, this can be implemented by the controller 1500 supplying power to a red LED 1503 on receipt of a signal from the document counter 1506. The croupier can then quickly see that an error has occurred. The TDU controller 1500 within the TDU 100 will also disable the quick key 101, S308, so, even if the croupier tries to activate it, the notes 301 will not be deposited into the secure cassette.

In other embodiments of the current invention, the function of the quick key 101 can be selected from a series of functions based on the result of the processing step. For example, if the processing is unsuccessful due to a note or paper jam the quick key 101 can simply be disabled as before. This allows the croupier to remove the notes 301 and re-submit them to the inlet 103. On the other hand, if the processing is unsuccessful due to invalid notes 103, the TDU controller 1500 can send a signal to the remote data processing server 207 on activation of the quick key 101. The information can be sent over a wireless communications channel 201, 1509 via a communication device 1508 connected to the TDU controller 1500. The server 207 is typically monitored by a member of management staff, who can then decide to either physically or remotely, via CCTV, inspect the TDU 100 or gaming table. Likewise, on successful processing, the function of the quick key 101 can be set to reflect the type or denomination of note processed; for example, £50 notes could be deposited in a separate secure cassette within the TDU 100. As known casinos in the UK often fall short of supplies of this note, due to £50 being the highest available denomination, the separate cassettes could be removed from the TDUs at times of high demand to restock the casino.

In certain situations, the escrow door 105 will be locked, and thus when an error occurs and the quick key 101 flashes or continually glows red, the croupier can signal to a higher level of management, possibly using the previous method, to come and unlock the escrow door 105. Management staff can then either physically unlock the door 105 at the gaming table or, upon receipt of an error signal sent from the TDU, remotely send a signal to the TDU controller 1500, over the communication channel 201, 1509, to actuate an unlocking mechanism 1504.

The croupier and/or management staff can then inspect the notes 301 to see whether they are valid S413. In certain implementations, once the escrow door 105 is opened, the quick key 101 and quick key function are reset. This then switches the system to its initial state, ready for new deposits. Thus, if the notes do seem to be valid, they can be re-supplied to the document inlet 103 and re-processed. This may be the case if the processing was unsuccessful due to a blocked note or a mistaken reading. If the notes do not appear to be valid then further management may be called S414 and the appropriate action taken.

In other implementations where there exists a high level of trust between management and croupier, the escrow door 105 can be left unlocked. However, to retain security the system can be designed so that, when the escrow door 105 is opened, the door actuates a sensor which sends a signal to the TDU controller 1500. The TDU controller 1500 then forwards an alert to the remote data processing server 207 to inform the management staff monitoring the system that the escrow door 105 is open. The management staff, for example the pit boss, is then able to remotely supervise the inspection of invalid notes 301 by the croupier over the casino CCTV system.

Preferably, the escrow door 105 is clear and the temporary store is provided with an internal light so that the croupier is able to inspect the notes in the temporary store without unlocking or opening the escrow door 105. In this way, the croupier may be able to infer why the processing of the note produced an error, for example if he spots an overly crumbled note, the note being the result of a note jam, he is better placed to quickly inform any management that are subsequently called on the current status of the TDU 100.

Alternatively, within the scope of the current invention, the quick key 101 could be an illuminated switch or an area on a touch screen. The illumination could take the form of different colours, different flashing frequencies, different images or a lack of illumination. For example, if the processing was unsuccessful the quick key 101 could remain unlit, transmitting the information that an error has occurred.

If a TDU 100 is placed so that two tables can use the unit to deposit cash then a further set of operational steps are required. Bank notes 401 are supplied to the inlet 103 as before, S402, but now the user has a choice of which quick key to press, S403, either the original quick key 101 if the table is to the right of the TDU 100 or a second quick key 102 if the table is to the left of the TDU 100. The controller 1500 within the TDU 100 then records which buttons have been pressed e.g. in the current example either button 1 or button 2. This is recorded as the index N as shown in step S404. Once the croupier has pressed the key the notes will proceed to be fed into the TDU as before.

If a processing step, S405, has been successful then the quick key which the croupier originally pressed will be illuminated green, S407. For example, if the croupier pressed the second quick key 102 then this quick key will now be illuminated. As before this particular quick key will also be enabled, S408, and the croupier can press the key to deposit the notes into the secure cassette within the TDU, S409. If the processing is not successful then the respective quick key will be illuminated red, S410, and as before the quick key will also be disabled, S411. A similar process of inspection S413 is then carried out. As stated previously, a variety of illumination methods and functions can be linked to the particular quick key selected.

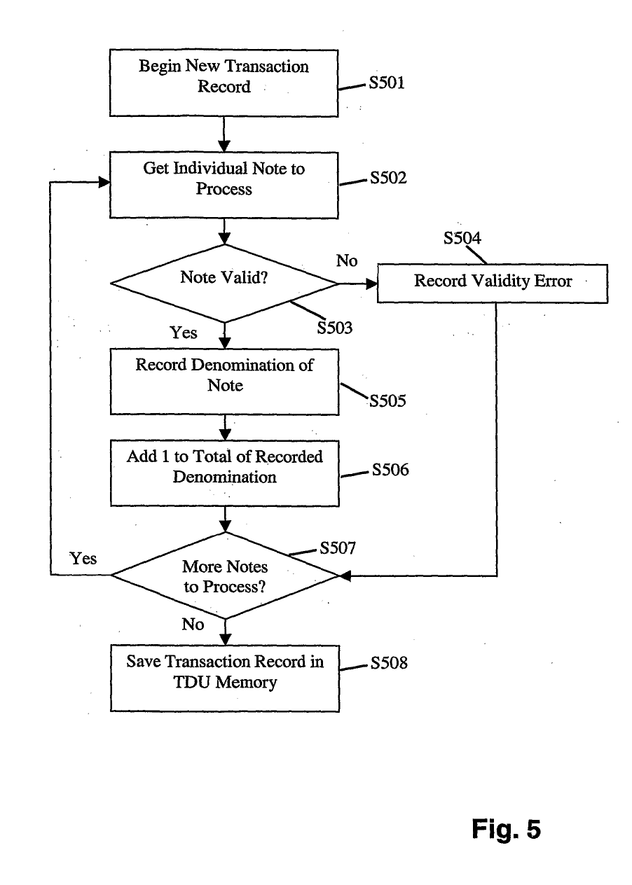

The processing of the notes or documents as referred to in steps S303 and S405 will now be described in more detail with reference to FIG. 5. Once the notes are fed into the processing means a new transaction record is created by the controller 1500 in the TDU memory 1507, S501. If multiple croupiers are sharing one TDU 100, an entry is marked in the transaction record to specify the current user. This could take the form of an index field storing the index N. Thus, for example, one TDU 100 could have two sets of transaction records, corresponding to two different tables. This then allows these records to be sorted and assigned to the respective table in later data processing. The processing means will then take one note at a time, S502, and first check its validity, S503. Possible authentication features could be machine readable infrared markings upon a bank note, such as is present within certain currencies including the Euro. Alternatively, an ultra violet detector, any other conventional banknote authenticity detector, can be provided to facilitate an entry level of counterfeit detection. If the note is found not to be valid an error is recorded in a transaction log, S504, and the next note to be processed is obtained, S507. Once an error is detected the system can either feed the remaining notes into the temporary store without processing, or continue to process any remaining notes. If the former method is chosen only one error per transaction will be recorded in the log, as after a first error no more processing will occur. This implementation could be beneficial if time is limiting. However, the latter case will provide a record in the transaction log of all errors that occur after an initial error, as each note will still be processed. This is beneficial as it enables a member of staff examining the transaction log to deduce which note in particular may have a problem. The detection of an error will also illuminate the relevant quick key red as in S306, S411.

If a note is valid then the denomination of the note is obtained and recorded, S505. This may be achieved using a detector which optically determines the value of each note by measurement of the long and short edges of the note. Alternatively, pattern recognition or infrared or magnetic thread coding could be used. The use of any particular method depends on the currency in-use within the casino and the country of residence. Once the denomination of the current note has been determined then the total for the particular denomination processed is incremented, S506. The next note then is selected and the process continues, S507. Once all the notes deposited in the inlet 103 have been processed, a complete transaction record is saved in the TDU memory 1507, S508. Alternatively, a system within the scope of the current invention could be designed so that a transaction record was saved in TDU memory 1507 for each individual note.

In alternate embodiments of the TDU 100 a remote display can be connected. This display can either be table mounted and thus connected to the TDU 100 via standard communication means or mounted upon the TDU 100 through the use of a height adjustable pole. This remote display preferably utilises light emitting devices that can be read by cameras and people from a distance of at least four metres. This then allows a pit boss to visually confirm deposits or spot errors from a variety of positions within the casino or via CCTV. The value of a transaction is preferably displayed on the remote display if a transaction is successful. This allows the customer to confirm or dispute the articles of value exchanged in a transaction. If an error occurs a code such as “00000000” is preferably displayed on the remote display. This allows a roving inspector or pit boss to easily spot the error. A similar code can also be displayed when the escrow door 105 is opened.

After the processing of the notes the remote display can also be adapted to flash the value of the transaction on the display. The customer then confirms this flashing total and the croupier presses the relevant quick key. Once the quick key is pressed, in the case of a successful transaction, the display will no longer flash and the amount statically shown on the remote displayed will be the amount deposited into the cassette.

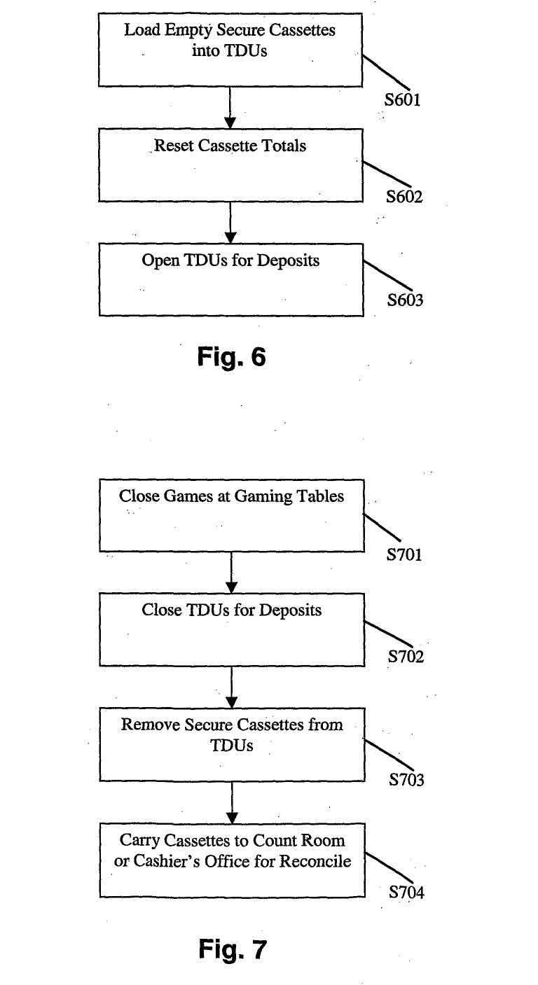

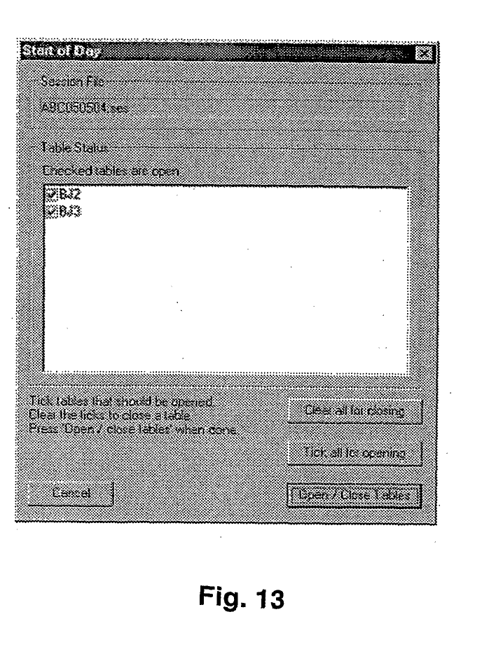

To set up the data processing system to obtain transaction data requires the method shown in FIG. 6. This is typically undertaken at the beginning of a gaming day. First, empty secure cassettes are loaded into the required TDUs, S601. Second, if it is required, the cassette totals are reset from the previous day, S602. Thus the total within each mounted cassette is zero. A TDU 100 has two standard operation modes: “open” or “closed”. The default configuration for each TDU 100 is “closed”. This means that no deposit can be made at the TDU 100 and the escrow door 105 is locked. In order to accept deposits and activate the TDU 100 each unit must be “opened”, S603. This is performed by the pit boss using the data processing server 207. An example of an interface used to carry out this procedure is shown in FIG. 13. This remote control of the TDU 100 can also be used during the gaming day to “lock down” a particular gaming table through closing the respective TDU 100. In certain embodiments, the lock connected to the access door 107 can be linked to the TDU controller 1500 so that, when the TDU 100 is “closed” the access door 107 is unlocked and staff can retrieve the secure cassette and when the TDU 100 is “open” the access door is locked and access to the secure cassette is denied.107

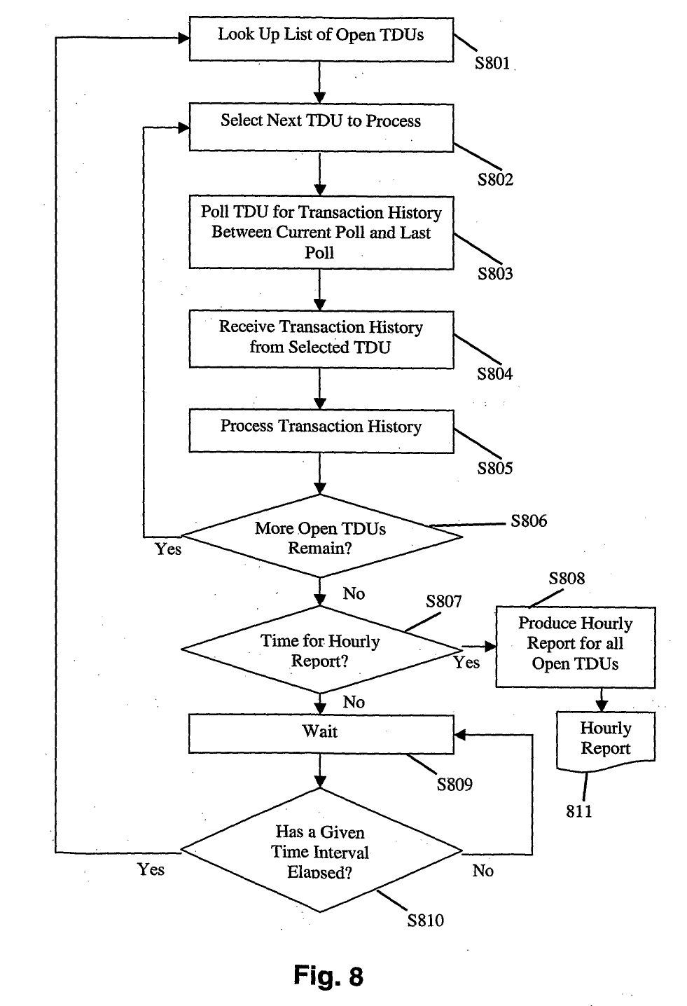

Once the required TDUs have been “opened”, the casino itself opens to customers and the gaming day begins. Each TDU 100 can now accept deposits as specified previously. The recorded transaction history of each TDU now needs to be collated by the remote data processing server 207. This is performed by a process similar to that in FIG. 8. Firstly, a list of “open” TDUs is loaded by the data processing server 207, S801. From this list the next TDU 100 to process is selected, S802. The data processing server 207 will then poll the selected TDU 100 over the relevant communication link 201, 1509 to ask the TDU controller 1500 for any transactions recorded in the time interval between the current poll and a previous poll, S803. Once a TDU 100 receives this polling request it sends the required transaction history from its memory 1507 over the communication link 201, 1509 to the data processing server 207, S804. The data processing server 207 then processes this received transaction history, S805. Once the history has been processed, the system moves to the next TDU 100, if one exists, and repeats the polling method, S806. It is conceivable that an alternate method within the scope of the current invention could also involve first receiving the transaction history from all required TDUs, storing the records in a queue, and then processing all the history in a batch operation as is known in the art. Furthermore, it is conceivable that a TDU 100 could also send transaction information to the data processing server 207 asynchronously after each deposit is made.

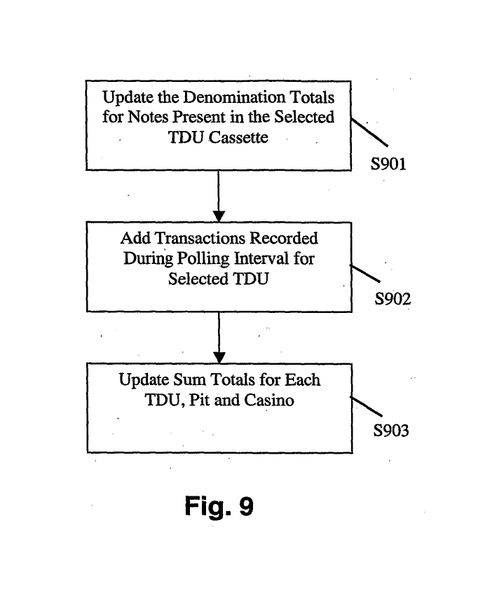

Step S808 is described in more detail in FIG. 9. First, each transaction is analysed. From FIG. 5 it was seen that within a transaction the denomination and number of each note deposited was recorded. Therefore, the total number of notes of each denomination deposited in the polling period can be extracted from the history and added to the relevant details stored for a particular TDU 100. This information is stored in a central database 209, S901, located either at the data processing server 207 or at a different remote location. Within this central database 209 there is thus an up-to-date record of the denominations of all notes stored in each secure cassette within each TDU 100. The transaction details themselves are also added to a transaction log for each TDU 100, S902. This is again stored at the central database 209 and includes details of any errors that have occurred. Thus, the management staff have access to details of each transaction executed during the day. Finally, the total amounted deposited in each cassette, and thus within the casino as a whole, can be calculated and stored in the central database 209. This database can be interrogated through user interfaces to obtain details about each individual TDU and the deposits made at each gaming table. Examples of the reports that can be provided could be, but are not limited to, a list of all the transactions made between a set time period, the number of errors that have incurred, or the total amount deposited.

There is also the option for the data processing server 207 to generate an hourly report 811. Returning to FIG. 8, after all “open” TDUs have been processed the server will check whether it is time for an hourly report 811 to be generated, S807. If it is, then a report 811 will be produced based on the information gathered in the previous hour, S808. This will automatically provide the pit boss with an overview of the last hour of gaming. It also allows a grand total breakdown and breakdowns by table to be provided. In a known casino environment, it is customary for the pit boss to visit each gaming table individually and manually record the deposit estimates each croupier has recorded on their “clicker”. This report supersedes this process, freeing up vital management time. The report 811 can be printed on printer 208 or sent to other management staff.

If it is not time to produce an hourly report 811 the system will wait a set amount of time, S809, usually 30 to 60 seconds depending on the number of TDUs and the system specification. Once this time has elapsed it will begin the polling process again as represented by step S810.

This process of depositing and polling continues throughout the gaming day until it is time for the casino to close. At this time, the method illustrated in FIG. 7 is initiated. First, the games at individual gaming tables are closed, S701. The pit boss can then close each TDU 100 for deposits at its respective table, S702. This is performed in a similar way to step S603 in FIG. 6, and is facilitated by an interface such as that shown in FIG. 13. Once all TDUs have been closed then the process of collecting the deposits can begin. In one embodiment, data processing server 207 sends a signal to each TDU 100 on close to release the access door 107. This, can be implemented by the TDU controller 1500, in a similar way to the unlocking of the escrow door 105. Thus the secure cassette can only be removed when the table is closed, preventing possible malicious access during the day. The secure cassettes are then removed from each TDU 100, S703, and carried to either a count room or the cashiers office for a reconcile procedure, S704.

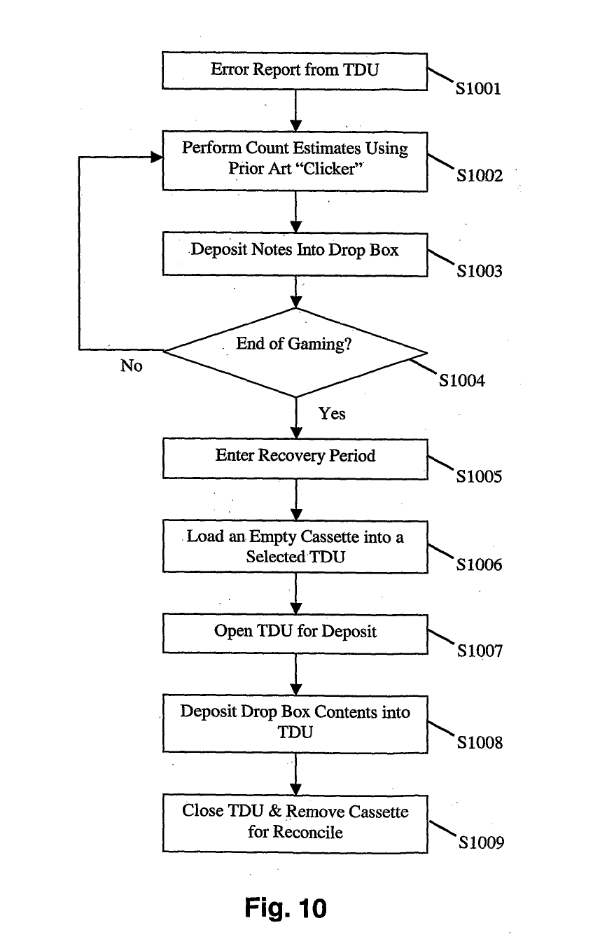

If an error occurs with a TDU 100 during the gaming day a recovery procedure can be put into place. This is illustrated in FIG. 10. First, an error report would be received from a TDU 100 and displayed upon the data processing server 207, S1001. In one embodiment of the current invention certain errors can be automatically relayed by the software to a pager system carried by management personnel. This is illustrated in FIG. 2, items 206 and 204. A pit boss or inspector can then proceed to inspect the erroneous TDU 100 to try to find the source of the error. If the error can not be corrected then the TDU 100 is closed using the data processing server 207, and the croupier is told to use the standard method of cash deposits. Deposit totals are thus estimated using the “clicker”, S1002, and notes are deposited via a slot in the table into a drop box, S1003, where the cash is stored. The croupier continues in this manner until the end of the gaming day, writing down his count estimates at regular intervals in order to provide a running total of the amount of cash deposited in the drop box. This information may be entered into the data processing server 207 manually.

When gaming at the table ends, for example at the end of the gaming day, a recovery period is entered, S1005. This lasts a short period of time after all the TDUs have been closed, for example a half or a quarter of an hour, and provides time to deposit cash into TDUs from the drop boxes without interfering with standard gaming table deposits. This recovery procedure begins by first selecting a free TDU 100, for example one that has previously had its original secure cassette removed. A new empty cassette is loaded into this selected TDU 100, S1006, and the TDU 100 is “opened” for deposit by the pit boss using the data processing server 207, S1007. The contents of the stand-in drop box are now deposited into the TDU 100 in the standard manner, see S1008 and FIGS. 3 and 4. After the entire contents of the drop box have been deposited into the secure cassette, the TDU 100 is “closed” and the cassette is removed, S1009. To facilitate this procedure the data processing system can store a list of each secure cassette, together with its associated gaming table and TDU 100.

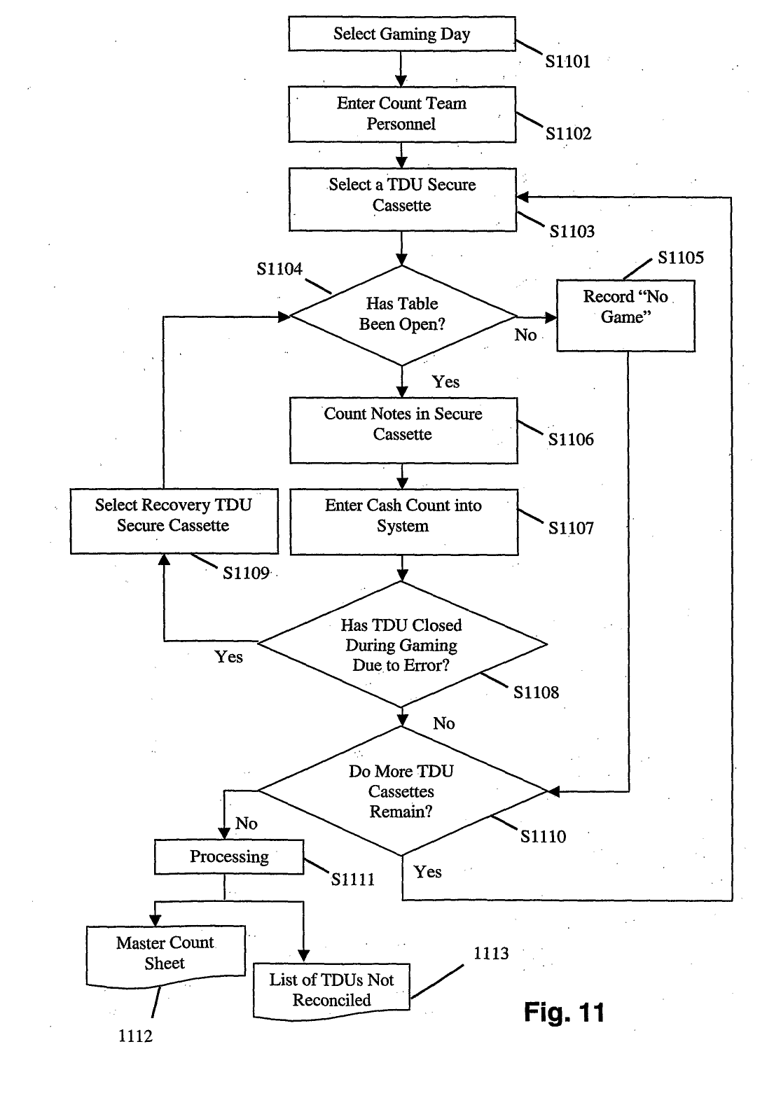

To provide security for deposits, which often was not present with drop boxes, the secure cassette is fitted with a lid that locks when it is withdrawn from the TDU 100. This feature, together with tamper indicating features, allow casino management to confirm that a cassette has not been tampered with between removal from the TDU 100 and transport to a secure central count room. Once all operational secure cassettes have been taken to the central count room the process of reconciliation can begin. This process is demonstrated in the FIG. 11. It is achieved using the data processing application located upon a number of terminals or a server 210 within the count room, as seen in FIG. 2. The data processing application can further be interfaced to automatic bank note counters 211, 212.

The procedure begins by select a gaming day, S1101. Usually this is either the same day or the previous day, if a count is done the next morning. The counting personnel present enter their details into the system so that, if a discrepancy is found, later checks can be made. The count team then set to work on counting the contents of each TDU secure cassette. A first TDU secured cassette is selected, S1103, and it is checked to see whether the corresponding table has been “opened”, S1104; if a table has not been “opened”, “no game” is recorded in the accounts computer system and another cassette is selected; if the table has been “opened”, the counting personnel removes the notes from secure cassette and performs a count, S1106. The count follows a similar procedure to that performed in the TDUs, i.e. the number of each denomination of notes within the cassette is recorded and the validity of these notes is also checked. The notes can be either counted manually, S1107, or using the automatic bank note counters 211, 212. If the latter is used, automatic counts can be directly entered into the data processing server 210, bypassing step S1107. This latter method only requires one trained staff member to be present in the count room, thus reducing costs compared to prior art methods, where up to five people needed to be present.

This counting of notes is continued until the secure cassette from the selected TDU is emptied. The records are then checked to see whether the TDU and/or gaming table has closed, during gaming, due to an error, S1108. If it has, then a recovery TDU may have been used and a secure cassette may exist as a recovery cassette for the selected table. If a recovery cassette does exist, this cassette is located and the count process repeated, S1109. After the current cassette count, including any possible recovery cassettes, has been completed then the count staff selects the next secure cassette and the process begins again, S1110.

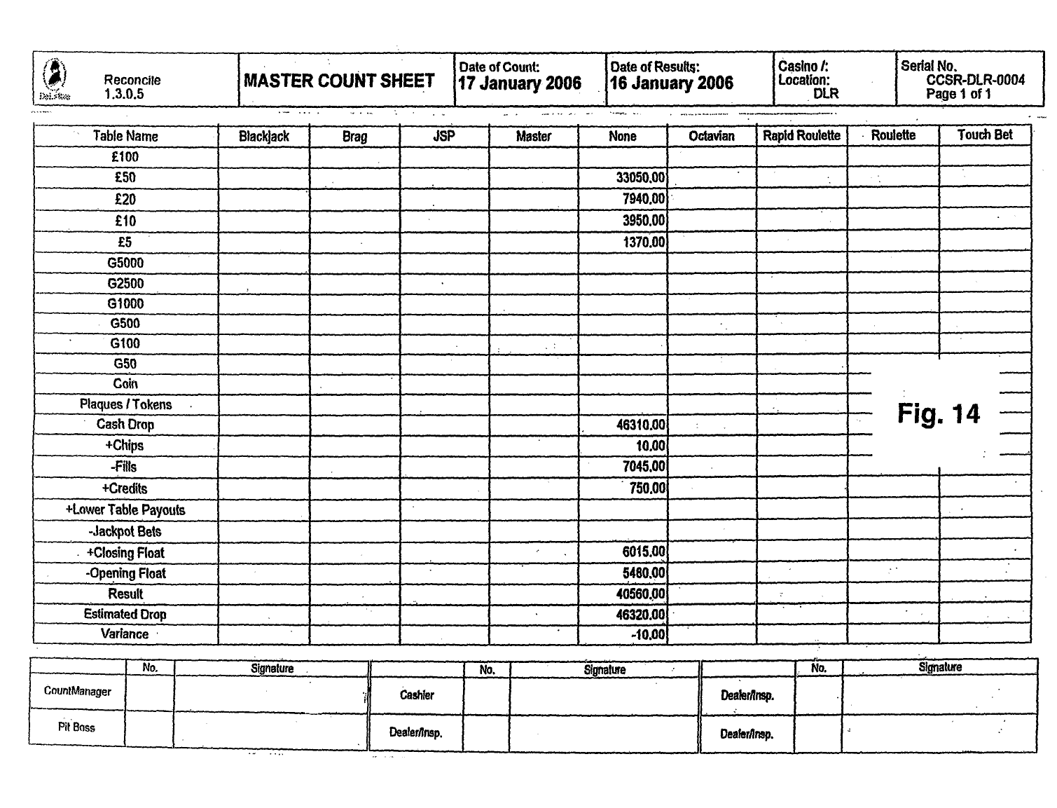

After all the secure cassettes have been counted and the details entered or transferred into data processing software, the data is processed to compare the data entered during the reconciliation count with the original data recorded by each TDU during the gaming day, S1111. This information is then displayed within a master count sheet 1112, which can either be displayed on screen or printed on printer 213. An example of this master account sheet is provided in FIG. 14. Before the use of the current invention this master count sheet was drawn up by hand and could contain large variances. Using the current invention, this master count sheet is based on hard data and the variance is kept to a minimum. Where some variance does occur this can also be denoted accurately. This master count sheet can then be used by auditors and/or official overseers to confirm that the casino is operating correctly and that a minimum amount of fraud is occurring. A list of TDUs that have not been reconciled 1113 is also produced by the data processing, S1111. This list contains any TDUs that have been open but do not have an associated secure cassette count.

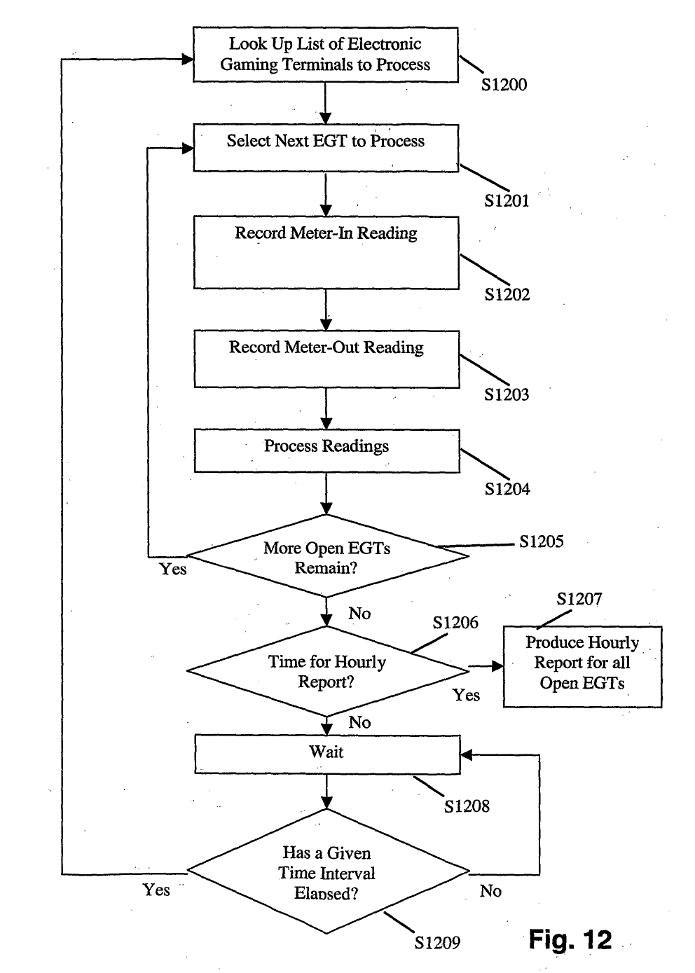

The procedures described above can also be extended to electronic gaming terminals within casinos. In these embodiments, meters mounted within an electronic gaming terminal operate in a similar manner to a TDU 100 at a gaming table. In this situation, a meter-in reading, taken from a meter attached to the electronic gaming terminal, is analogous to a transaction recorded by a TDU 100. If the in and out meters are networked into the casino data processing system in a similar manner to the TDUs, then at each TDU polling cycle the meter readings can be read from each terminal and stored in the central database 209 with the TDU data. This process is demonstrated in FIG. 12. Alternatively, the meter readings on any terminals that are not networked can be recorded by an inspector or pit boss in the conventional manner and then manually inputted into the data processing application within the pit boss or cashier desk terminal 207.

To reconcile electronic gaming terminal cassettes, wherein any cash deposited into the terminal resides, a similar operation to FIG. 11 is undertaken. In this instance, an electronic gaming terminal cassette is selected instead of a TDU cassette and the operation proceeds in a similar manner to that demonstrated in steps S1100 to S1111. In the processing step, S1111, a cash drop estimate for the day is calculated from the difference between two meter-in readings, recorded respectively at the beginning and end of the gaming day. This is compared to the amount of cash counted from the cassette to gain variance estimates. A further payout estimate is calculated from the difference in meter-out readings for the same time period. This is compared with cash desk payout records. These figures are then displayed in the Master Count Sheet together with those obtained in a similar manner from TDUs.

To facilitate the use of the described system with articles of high monetary value, such as the plaques discussed in the introduction, the current invention further proposes a casino currency. A customer will purchase a certain amount of casino currency at a cashier station in exchange for payment by standard means, and then use this currency to purchase chips at a gaming table. Alternatively, the casino currency can also be distributed to winning customers instead of cash, plaques or tickets.

This casino currency eliminates the problems associated with articles of high monetary by providing a series of authentication and validation features which are usually found on standard legal tender bank notes, but the casino currency having no value outside of the casino since not being legal tender. These features include but are not limited to a mould-made watermarked paper with windowed cleartext thread, all over lithographic print on face and reverse of the currency, a single document size, a rainbow print area, anti-copy print features, infrared denomination encoding with type matched inks, infrared blind lithographic print background, and a unique sequential serial number. Further options for such currencies include the use of intaglio printing, holographic patches or stripes, bar codes, or radio frequency identification tags on threads. The same features can be used in the validation of banknotes within the deposit method.

The currency can also contain covert machine readable infrared features that allow a TDU 100 to simultaneously authenticate and denomination the casino currency. Therefore, the size of any document will only be used as a prompt to the detector to check the infrared pattern. Any documents not matching the infrared requirements will be rejected as suspect counterfeit. Therefore, the casino provides a currency system which provides enhanced security, sometimes exceeding that provided by legal tender, and allows greater authentication certainty. The processing means within each TDU 100 is thus adapted to recognise these features of the currency.

1. A method of operating a document deposit apparatus comprising the steps of:
a) supplying at least one document to a document inlet area;
b) processing the at least one document;
c) selectively illuminating a manually operable input means so as to inform a user of the success or otherwise of the processing step;
d) setting the function of the input means dependent on the result of the processing step; and
e) selectively activating the input means to implement the function.

2. The method according to claim 1, further comprising the step of:
b1) depositing the processed at least one document into a temporary store before selectively illuminating the input means;

3. The method according to claim 1, wherein step (a) further comprises:
(a1) designating a user responsible for a document deposit by first activating one input means from a plurality of input means to associate the user with the activated input means;
and step (c) further comprises selectively illuminating the input means associated with the user.

4. The method according to claim 1, wherein step (c) further comprises:
(c1) selectively illuminating the input means a first colour if the process step was successful; and
(c2) selectively illuminating the input means a second colour if the process step was unsuccessful.

5. The method according to claim 4, wherein step (d) further comprises:
(d1) setting the function of the input means to allow the at least one document to be deposited into a deposit store upon activation of the input means if said process step was successful; and
(d2) disabling the input means if said process step was unsuccessful.

6. The method according to claim 1, wherein the illumination condition and function of the input means is reset to an initial state upon a user accessing the temporary store and removing the at least one document.

7. The method according to claim 1, wherein the manually operable input means comprises a single button or switch.

8. The method according to claim 1, wherein the manually operable input means comprises a single location on a touch screen.

9. The method according to claim 1, wherein step (b) determines one or more characteristics of the at least one document.

10. A method for operating an article of value deposit and audit system within a casino environment comprising:
a) depositing a plurality of articles of value onto at least one deposit apparatus located at a gaming table;
b) processing said plurality of articles of value at the gaming table using said deposit apparatus;
c) storing the plurality of articles of value in a secure container within the deposit apparatus;
d) transmitting a first set of information relating to the article of value processing in step (b) over a communication means to a central location; and
e) storing said first set of information at the central location.

11. The method of operating an article of value deposit and audit system according to claim 10, further comprising:
f) controlling said deposit apparatus over the communication means from the central location.

12. The method of operating an article of value deposit and audit system according to claim 11, wherein step (f) comprises activating or deactivating said deposit apparatus over the communication means from the central location.

13. The method of operating an article of value deposit and audit system according to claim 11, wherein step (f) further comprises:
f1) preparing the deposit apparatus to accept deposits at the beginning of gaming for a particular table;
f2) disabling the deposit apparatus at the end of gaming for a particular table.

14. The method of operating an article of value deposit and audit system according to claim 13, wherein the beginning and end of gaming for a particular table is equal to the beginning and end of a gaming day.

15. The method of operating an article of value deposit and audit system according to claim 10, further comprising the steps of:
g) collecting at least one secure container from the at least one deposit apparatus;
h) processing the plurality of articles of value contained within the at least one secure container to generate a second set of information related to the articles of value; and
i) reconciling the first and second sets of information and reporting the results.

16. The method of operating an article of value deposit and audit system according to claim 15, wherein:
step (h) comprises denominating and totaling the plurality of articles of value contained within the container; and
the second set of information comprises the denominations and totals of all the articles of value deposited into the secure container.

17. The method of operating an article of value deposit and audit system according to claim 10, wherein:
step (b) comprises denominating and totaling the plurality of articles of value deposited into the said deposit apparatus;
the first set of information transmitted in step (d) comprises the denominations and totals of the deposited articles of value; and
step (e) further comprises calculating and storing a total of each denomination and the total deposited within each deposit apparatus.

18. The method of operating an article of value deposit and audit system according to claim 17, further comprising:
j) comparing the article of value denominations and totals for each document deposit apparatus obtained in step (h) with the totals of the article of value denominations and totals for each document deposit apparatus obtained from the first set of information and stored at the central-location; and
k) displaying the information compared in step (j) in a tabular format, wherein:
step (b) comprises denominating and totaling the plurality of articles of value deposited into the said deposit apparatus;
the first set of information transmitted in step (d) comprises the denominations and totals of the deposited articles of value; and
step (e) further comprises calculating and storing a total of each denomination and the total deposited within each deposit apparatus.

19. The method of operating an article of value deposit and audit system according to claim 17, further comprising:
1) resetting the totals of each deposit apparatus at the beginning of the gaming day for a particular table.

20. The method of operating an article of value deposit and audit system according to claim 16, wherein the articles of value are denominated using at least one of pattern recognition, size detection, or infra red coding or magnetic thread coding located on each document.

21. The method of operating an article of value deposit and audit system according to claim 10, wherein step (b) includes the step of validating the authenticity of the articles of value.

22. The method of operating an article of value deposit and audit system according to claim 15, wherein step (h) includes the step of validating the authenticity of the articles of value.

23. The method of operating an article of value deposit and audit system according to claim 21, wherein the validation is performed upon the articles of value using at least one of the following security features: machine readable infra red or UV patterns, mould-made watermarked paper with a windowed cleartext thread, all over lithographic print on face and reverse of the currency, anti-copy print features, infrared denomination encoding with type matched inks, infrared blind lithographic print background, a unique machine readable sequential serial number, intaglio printing, holographic patches or stripes, bar codes, and radio frequency identification tags on threads.

24. The method of operating an article of value deposit and audit system according to claim 10 wherein the first set of information further comprises status information on the functionality of each deposit apparatus to enable the status of each apparatus to be checked from the central location.

25. The method of operating an article of value deposit and audit system according to claim 24 wherein one or both of an error contained within the status information and information related to a large deposit over a set threshold are paged to an appropriate management employee from the central location.

26. The method of operating an article of value deposit and audit system according to claim 10, wherein said communication means include one or more of a direct serial link, an ethernet connection or a wireless link.

27. The method of operating an article of value deposit and audit system according to claim 10, wherein the articles of value comprise one or more of banknotes, cheques, coins, credit plaques and other documents of monetary value.

28-30. (canceled)

31. A method for providing payment in a casino environment comprising the step of:
purchasing a casino currency using standard payment means; and
exchanging the casino currency for gaming chips at a gaming table or cashier;
wherein the casino currency includes at least one anti-counterfeit security feature.

32. The method of providing payment according to claim 31, further comprising the step of:
distributing the casino currency to winning customers.

33. The method of providing payment according to claim 31, wherein the security features comprise one or more of infra red or UV patterns, mould-made watermarked paper with a windowed cleartext thread, all over lithographic print on face and reverse of the currency, anti-copy print features, infrared denomination encoding with type matched inks, infrared blind lithographic print background, a unique sequential serial number, intaglio printing, holographic patches or stripes, bar codes, or radio frequency identification tags on threads.

34. A method for operating a document deposit and audit system according to claim 10 wherein the articles of value comprise casino currency.
